(19) United States
(12) Patent Application Publication
(10) Pub. No.: US 2026/0241842 A1
(43) Pub. Date: Aug. 20, 2026

(54) CHILD RESTRAINT

(71) Applicant: Dorel Juvenile Group, Inc., Foxboro, MA (US)

(72) Inventors: Kegan McKinney CRAWFORD, Foxboro, MA (US); Jason H. JOHNSON, Brownstown, IN (US)

(21) Appl. No.: 19/538,289

(22) Filed: Feb. 12, 2026

Related U.S. Application Data
(60) Provisional application No. 63/758,547, filed on Feb. 14, 2025.

(51) Int. Cl. B60N 2/28

(52) U.S. Cl. CPC B60N 2/2869; B60N 2/2821

(57) ABSTRACT

A child restraint includes a seat base, a juvenile seat, and a seat-pivot controller. The seat base is configured to be attached to a vehicle seat of a vehicle. The juvenile seat is configured to secure and restrain a child for transportation in the vehicle. The juvenile seat is configured to pivot relative to the seat base.

### PRIORITY CLAIM

This application claims priority under 35 U.S.C. § 119(e) to U.S. Provisional Patent Application No. 63/758,547, filed February 14, 2025, the disclosure of which is expressly incorporated by reference herein in its entirety.

### BACKGROUND

The present disclosure relates to a child safety device, and particularly to a child seat. More particularly, the present disclosure relates to a child seat adapted to be secured to a vehicle seat for transportation in a vehicle.

### SUMMARY

According to the present disclosure, a child restraint includes a seat base and a juvenile seat. The seat base is configured to be attached to a vehicle seat of a vehicle. The juvenile seat is coupled to the seat base and is configured to secure and restrain a child for transportation in the vehicle.

In illustrative embodiments, the child restraint further includes a seat-pivot controller configured to control movement of the juvenile seat relative to the seat base from a travel orientation to a first pivoted orientation or a second pivoted orientation. The seat-pivot controller includes a first pivot post or striker coupled to the seat base, a second pivot post or striker coupled to the seat base and offset in a first lateral direction from the first striker, and a lock controller coupled to the juvenile seat for movement therewith. The lock controller is configured to engage selectively with the first striker and the second striker in the travel orientation to block movement of the juvenile seat relative to the seat base from the travel orientation to the first pivoted orientation and the second pivoted orientation.

In illustrative embodiments, the lock controller is configured to release from the first striker to allow pivoting of the juvenile seat relative to the seat base about the second striker to the second pivoted orientation. The lock controller is configured to release from the second striker to allow pivoting of the juvenile seat relative to the seat base about the first striker to the first pivoted orientation. The lock controller is also configured to block release of second striker when the first striker is released and block release of the first striker when the second striker is released.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a top perspective view of a child restraint including a seat base, a juvenile seat configured to secure and restrain a child for transportation in the vehicle, and a seat-pivot controller configured to control movement of the juvenile seat relative to the seat base from a travel orientation to a first pivoted orientation or a second pivoted orientation and including;

FIG. 2 is a top perspective view of the child restraint of FIG. 1, showing the restraint in the second pivoted orientation;

FIG. 3 is an exploded view of the child restraint of FIG. 1, showing the seat base, the juvenile seat, and the seat-pivot controller including a first striker coupled to the seat base, a second striker coupled to the seat base and offset from the first striker, and a lock controller coupled to the juvenile seat and configured to engage selectively with the first striker and the second striker in the travel orientation;

FIG. 4 is a top perspective view of the seat-pivot controller shown in FIG. 3 showing the first striker, the second striker, and the lock controller including a housing configured to rotate relative to the seat base with the juvenile seat, a first pivot lock coupled to the housing for movement therewith and configured to engage selectively with the first striker, and a second pivot lock coupled to the housing for movement therewith and configured to move independently of the first pivot lock and engage selectively with the second striker;

FIG. 5 is an exploded view of the seat-pivot controller shown in FIG. 3 showing the housing including a first slot configured to receive the first striker and a second slot configured to receive the second striker, the first pivot lock including a first pivot latch, a first lock pawl configured to retain the first pivot latch in a first locked position, and a first actuator configured to release the first lock pawl from the first pivot latch, and the second pivot lock including a second pivot latch, a second lock pawl configured to retain the second pivot latch in a second locked position, and a second actuator configured to release the second lock pawl from the second pivot latch;

FIG. 6 is a top view of the lock controller shown in FIG. 4 showing the first and second pivot latches, lock pawls, and actuators in the first and second locked positions when the child restraint is in the travel orientation;

FIG. 7 is a top view of the lock controller shown in FIG. 4 showing the first pivot latch, lock pawl, and actuator moving from the first locked position to a first unlocked position when the first pivot latch is releasing the first striker and the child restraint is moving from the travel orientation to the second pivoted orientation;

FIG. 8 a top view of the lock controller shown in FIG. 4 showing the first pivot latch, lock pawl, and actuator in the first unlocked position, and the second pivot latch, lock pawl, and actuator in the locked position, when the first pivot latch has fully released the first striker;

FIG. 9 a top view of the lock controller shown in FIG. 4 showing, in the first and second locked positions, the first and second pivot locks and the first and second pivot latches including first and second retaining surfaces configured to engage with outside surfaces of the first and second strikers in the travel orientation, first and second catch surfaces configured to engage with the first and second lock pawls, first and second pivot latch catches engaging the first and second catch surfaces to block movement of the first and second pivot latches from the first and second locked positions to the first and second unlocked positions, first and second pawl catches configured to block movement of the first and second lock pawl, and first and second actuator connectors coupled to the first and second actuators, respectively;

FIG. 10 a top view of the lock controller shown in FIG. 4 showing, in the first unlocked position, the first pivot lock and the first lock pawl including the first pawl catch blocking movement of the second lock pawl;

FIG. 11 is an exploded view of a second illustrative embodiment of a seat-pivot controller showing a first striker, a second striker, and a lock controller including a housing, first and second pivot locks;

FIG. 12 is a top view of the lock controller shown in FIG. 11 showing first and second pivot latches, lock pawls, and actuators in first and second locked positions when the child restraint is in a travel orientation;

FIG. 13 is a top view of the lock controller shown in FIG. 11 showing the first pivot latch, lock pawl, and actuator moving from the first locked position to a first unlocked position when the first pivot latch is releasing the first striker and the child restraint is moving from the travel orientation to a second pivoted orientation; and

FIG. 14 a top view of the lock controller shown in FIG. 11 showing the first pivot latch, lock pawl, and actuator in the first unlocked position, and the second pivot latch, lock pawl, and actuator in the locked position, when the first pivot latch has fully released the first striker and the child restraint is in the second pivoted orientation.

### DETAILED DESCRIPTION

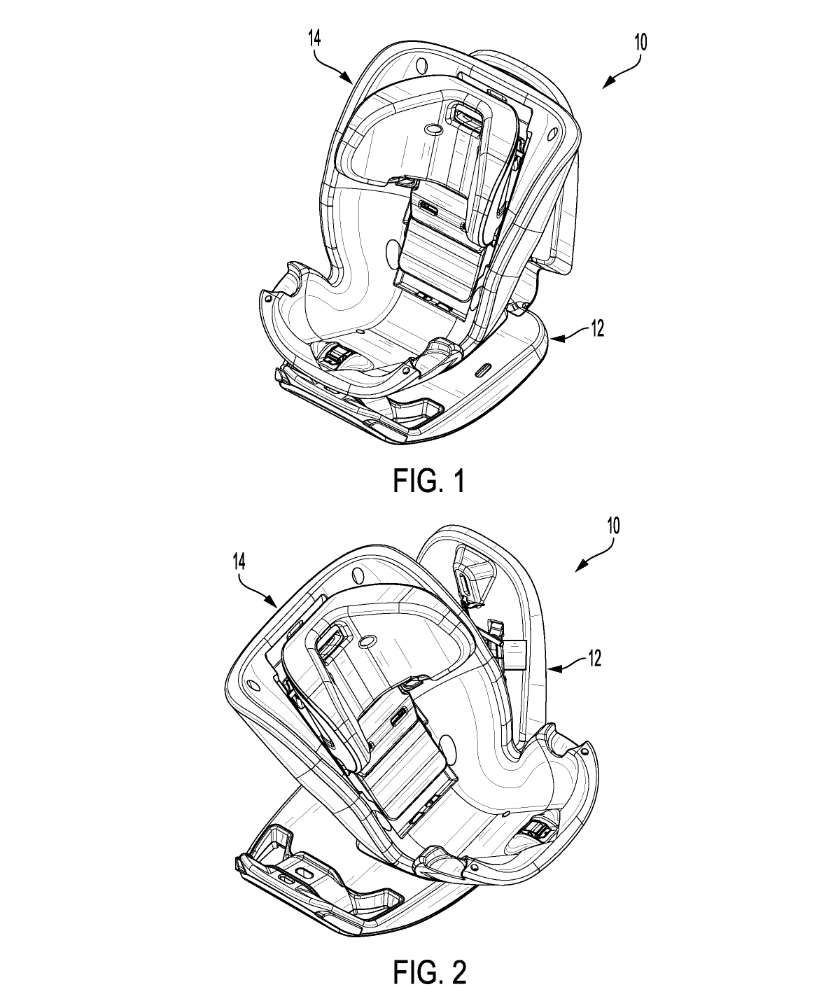

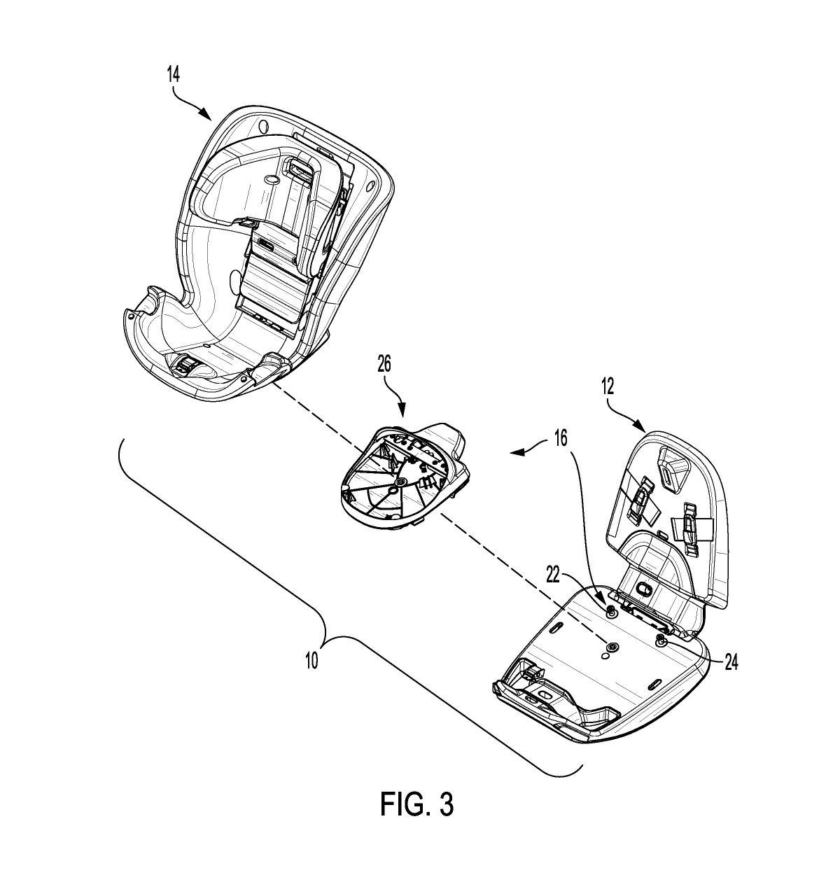

A child restraint 10 includes a seat base 12, a juvenile seat 14, and a seat-pivot controller 16, as shown in FIGS. 1-3. The seat base 12 is configured to be attached to a vehicle seat of a vehicle. The juvenile seat 14 is configured to secure and restrain a child for transportation in the vehicle. The seat-pivot controller 16 is configured to control movement of the juvenile seat 14 relative to the seat base 12 from a travel orientation, as shown in FIG. 1, to a first pivoted orientation or a second pivoted orientation, as shown in FIG. 2. While only the first pivoted orientation is shown, it should be appreciated that the second pivoted orientation is present when the juvenile seat 14 faces an opposite direction to what is shown in FIG. 2.

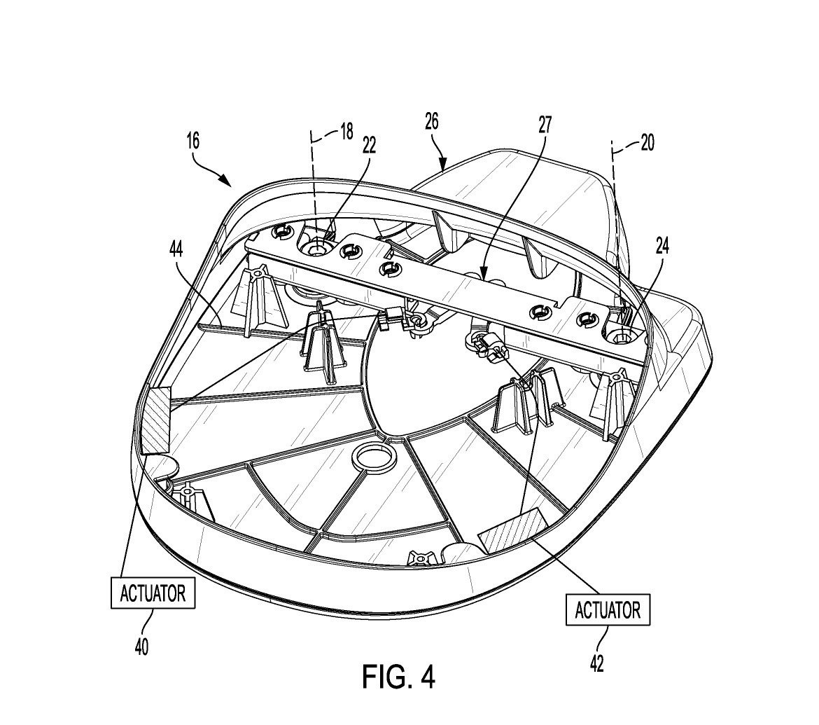

The seat-pivot controller 16 includes a first pivot post or striker 22 coupled to the seat base 12, a second pivot post or striker 24 coupled to the seat base 12, and a lock controller 26 coupled to the juvenile seat 14 for movement therewith, as shown in FIGS. 4-10. The second striker 24 is offset in a first lateral direction from the first striker 24. The lock controller 26 is configured to engage selectively with the first striker 22 and the second striker 24 in the travel orientation to block movement of the juvenile seat 14 relative to the seat base 12 from the travel orientation to the first pivoted orientation and the second pivoted orientation. The lock controller 26 is configured to release from the first striker 22 to allow pivoting of the juvenile seat 14 relative to the seat base 12 about the second striker 24 to the second pivoted orientation. The lock controller 26 is configured to release from the second striker 24 to allow pivoting of the juvenile seat 14 relative to the seat base 12 about the first striker 22 to the first pivoted orientation.

The first and second strikers 22, 24 are illustratively embodied as generally cylindrical components such as a rod, a bar, or a post. In other embodiments, the strikers 22, 24 may have a different shape or structure such as a u-shaped structure, a n-shaped structure, or a L-shaped structure. The first and second strikers 22, 24 are formed to include a notched central region to provide a lip or head that blocks vertical movement of the juvenile seat 14 and the lock controller 26 away from the seat base 12 while allowing for pivotable movement of the juvenile seat 14 and the lock controller 26 relative to each respective striker 22, 24.

The travel orientation of the juvenile seat 14 may be a forward-facing orientation or a rearward-facing orientation. The seat-pivot controller 16 is configured to allow the juvenile seat 14 to pivot about a first pivot axis 18, provided by the first striker 22 and offset in a first lateral direction from a front-to-back centerline 100 of the seat base 12, to the first pivoted orientation to position the juvenile seat 14 towards an open passenger-side door of the vehicle. The seat-pivot controller 16 is configured to allow the juvenile seat 14 to pivot about a second pivot axis 20, provided by the second striker 24 and offset in a second lateral direction, opposite the first lateral direction, from the front-to-back centerline 100 of the seat base 12 to the second pivoted orientation to position the juvenile seat 14 towards an open driver-side door of the vehicle. The first and second pivoted orientations serve to facilitate placement of a child into the juvenile seat 14, whether the child restraint 10 is positioned nearer the passenger side or the driver side of the vehicle.

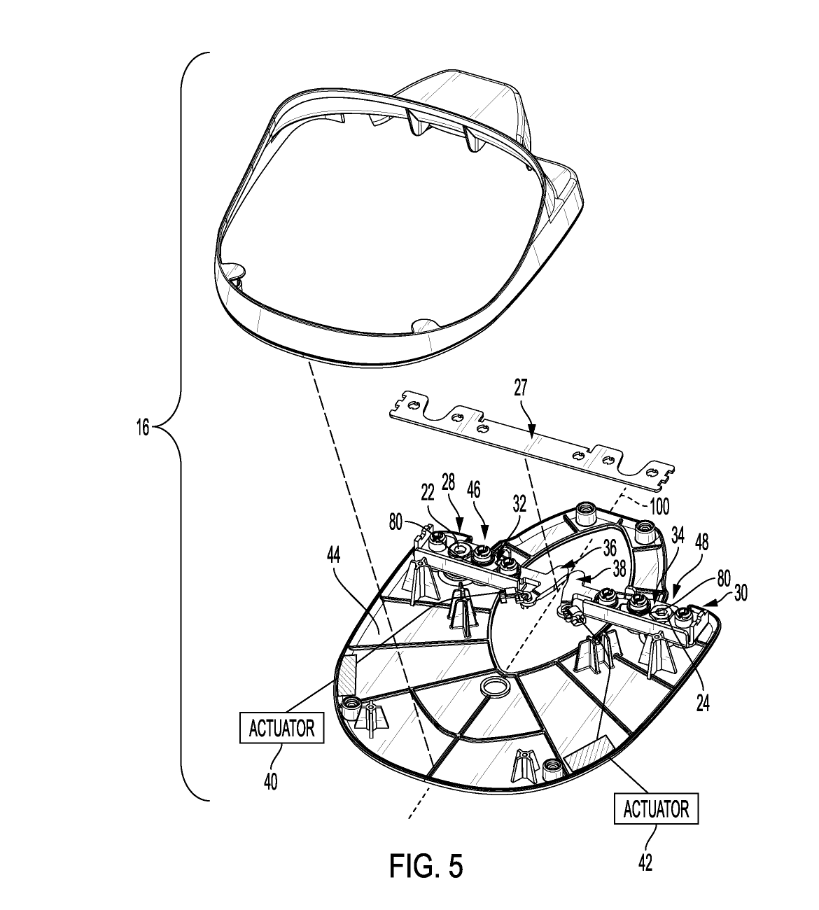

The lock controller 26 includes a housing 44 coupled to the juvenile seat 14, a first pivot lock 28 coupled to the housing 44 for movement therewith, and a second pivot lock 30 coupled to the housing 44 for movement therewith, as shown in FIGS. 5-10. The housing 44 is attached to a lower end of the juvenile seat 14 to interface with the seat base 12. The housing 44 is configured to rotate relative to the seat base 12 with the juvenile seat 14. In the illustrative embodiment, the housing 44 is formed as part of the juvenile seat 44. In some embodiments, the housing 44 may be a separate component from the juvenile seat 14. The first pivot lock 28 is configured to engage selectively with the first striker 22 in the travel orientation to block movement of the juvenile seat 14 relative to the seat base 12. The second pivot lock 30 is configured to engage selectively with the second striker 24 in the travel orientation to block movement of the juvenile seat 14 relative to the seat base 12.

The housing 44 is formed to include a first slot 46 and a second slot 48, as shown in FIGS. 5-10. The first slot 46 receives the first striker 22 in the travel orientation. The second slot 48 receives the second striker 24 in the travel orientation. The housing 44 cooperates with the first and second pivot locks 28, 30 to confine the strikers 22, 24 and block movement of the juvenile seat 14 relative to the seat base 12 in the travel orientation.

The first and second pivot locks 28, 30 are movable independently of one another. The first and second pivot locks 28, 30 each include respective first and second pivot latches 32, 34, first and second lock pawls 36, 38, and first and second actuators 40, 42, as shown in FIGS. 5-10. The first and second pivot latches 32, 34 are configured to grip and retain each respective striker 22, 24 in the travel orientation. Each lock pawl 36, 38 is configured to retain the respective pivot latch 32, 34 in respective first and second locked positions (as shown in FIGS. 4-10). Each actuator 40, 42 is operated by a user to release the respective lock pawl 36, 38 from the respective pivot latch 32, 34 so that a selected pivot latch 32, 34 is free to move from the locked position to a respective unlocked position (as shown in FIGS. 8 and 10). The first actuator 40 is configured to disengage the first lock pawl 36 from the first pivot latch 32 to free the juvenile seat 14 for pivotable movement about the first pivot axis 18. The second actuator 42 is configured to disengage the second lock pawl 38 from the second pivot latch 34 to free the juvenile seat 14 for pivotable movement about the second pivot axis 20.

The first pivot latch 32 is biased toward the first unlocked position by a spring 80 and is configured to automatically release the first striker 22 when the first lock pawl 36 is released. The second pivot latch 34 is biased toward the second unlocked position by a spring 80 and is configured to automatically release the second striker 24 when the second lock pawl 38 is released. The juvenile seat 14 is configured to selectively change between a locked configuration 58, in which the pivot latches 32, 34 are in respective locked positions, and an unlocked configuration 60, in which either the first pivot latch 32 or the second pivot latch 34 is in either of the first unlocked position or the second unlocked position, respectively.

The first lock pawl 36 is biased into engagement with the first pivot latch 32 and is configured to automatically lock the first pivot latch 32 in the first locked position when the juvenile seat 14 is returned to the travel orientation. The second lock pawl 38 is biased into engagement with the second pivot latch 34 and is configured to automatically lock the second pivot latch 34 in the second locked position when the juvenile seat 14 is returned to the travel orientation. The first lock pawl 36 and the second lock pawl 38 are configured to block each other from being released when the juvenile seat 14 is in the first pivoted orientation or the second pivoted orientation. In other words, when the first pivot latch 32 is released, the first pivot latch 32 is configured to position the first lock pawl 36 in a position that blocks release of the second lock pawl 38. When the second pivot latch 34 is released, the second pivot latch 34 is configured to position the second lock pawl 38 in a position that blocks release of the first lock pawl 36. Thus, both pivot latches 32, 34 cannot be released at the same time.

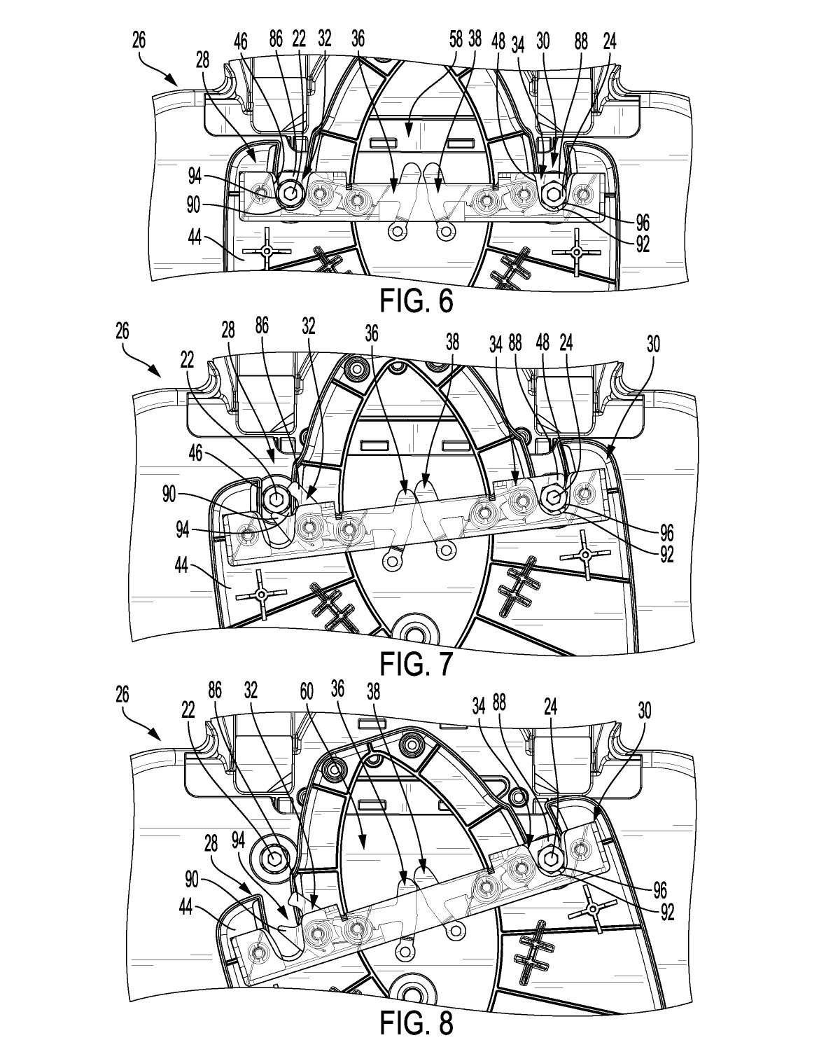

The first and second pivot latches 32, 34 each include respective first and second post retainers 86, 88 and first and second latch returns 90, 92 spaced apart from the respective post retainers 86, 88, as shown in FIGS. 6-10. A respective first and second post-receiving spaces 94, 96 is located between each respective post retainer 86, 88 and each respective latch return 90, 92.

The first post retainer 86 extends across the first slot 46 to at least partially enclose the first striker 22 in the first slot 46 when the juvenile seat 14 is in the travel orientation and the second pivoted orientation. The first post retainer 86 is misaligned with the first slot 46 when the first pivot latch 32 is in the first locked position to free the first striker 22 for withdrawal from the first slot 46 during movement of the juvenile seat 14 to the first pivoted orientation. The first latch return 90 extends across the first slot 46 when the first pivot latch 32 is in the first unlocked position to engage the first striker 22 during movement of the juvenile seat 14 from the first pivoted orientation to the travel orientation to return the first pivot latch 32 to the first locked position when the juvenile seat 14 reaches the travel orientation.

The second post retainer 88 extends across the second slot 48 to at least partially enclose the second striker 24 in the second slot 48 when the juvenile seat 14 is in the travel orientation and the first pivoted orientation. The second post retainer 88 is misaligned with the second slot 48 when the second pivot latch 34 is in the second locked position to free the second striker 24 for withdrawal from the second slot 48 during movement of the juvenile seat 14 to the second pivoted orientation. The second latch return 92 extends across the second slot 48 when the second pivot latch 34 is in the second unlocked position to engage the second striker 24 during movement of the juvenile seat 14 from the second pivoted orientation to the travel orientation to return the second pivot latch 34 to the second locked position when the juvenile seat 14 reaches the travel orientation.

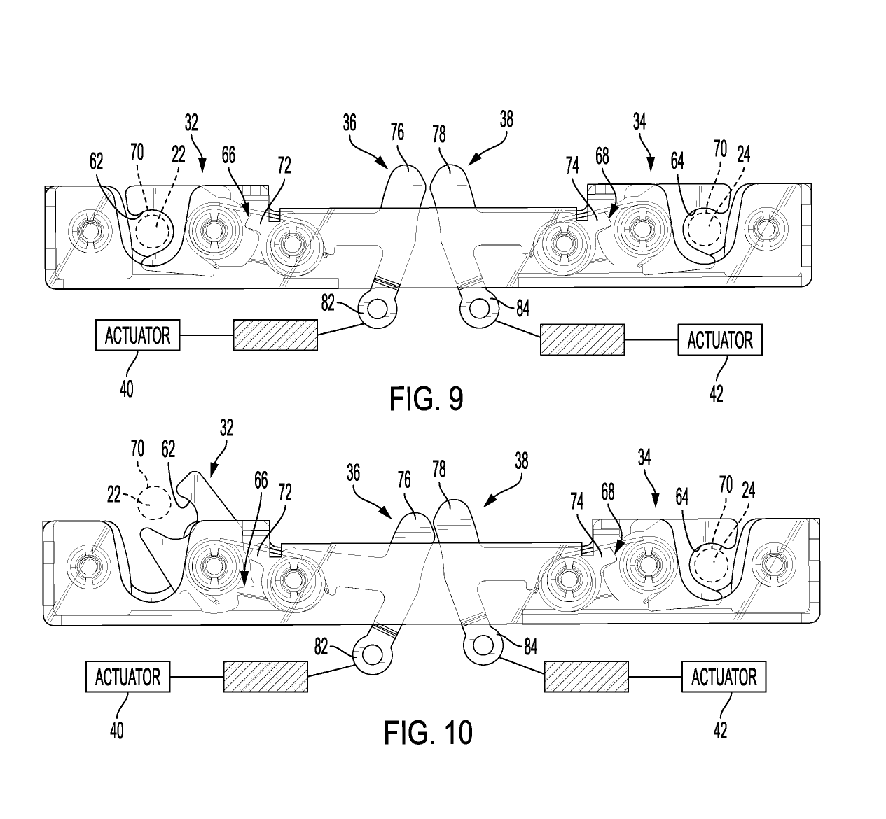

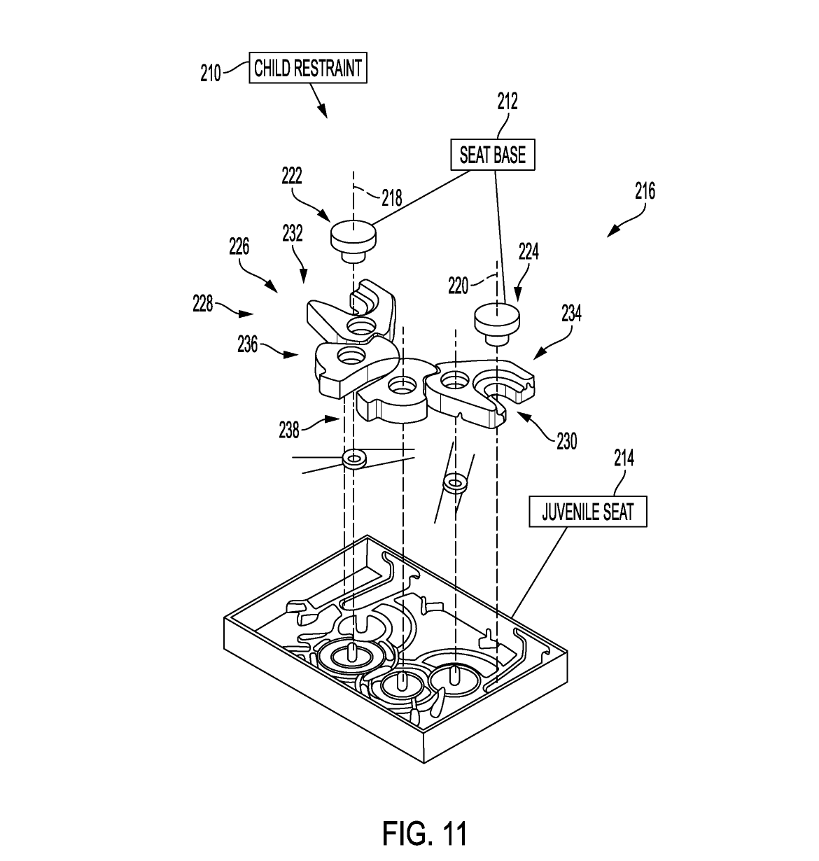

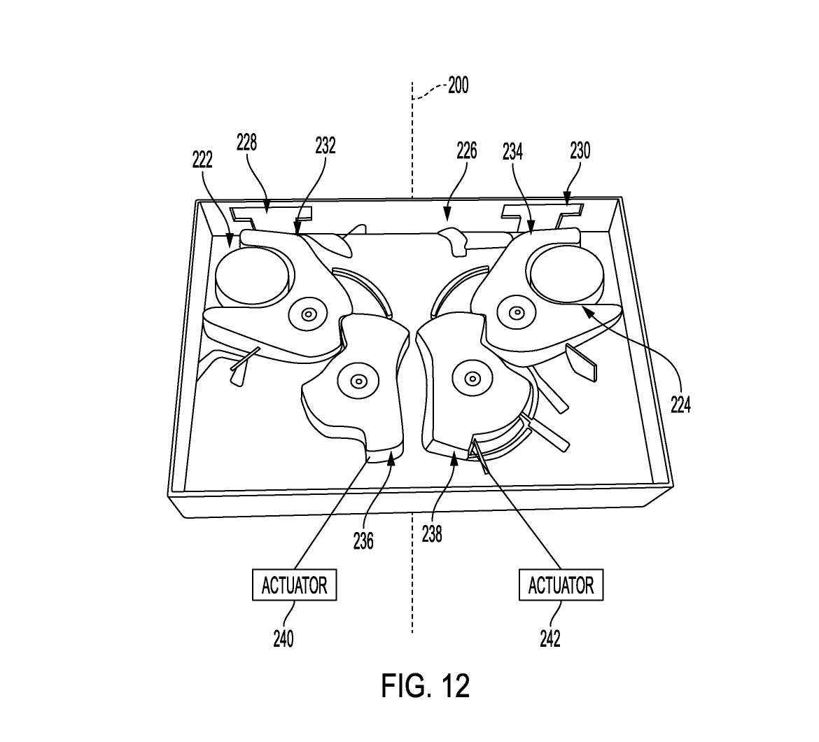

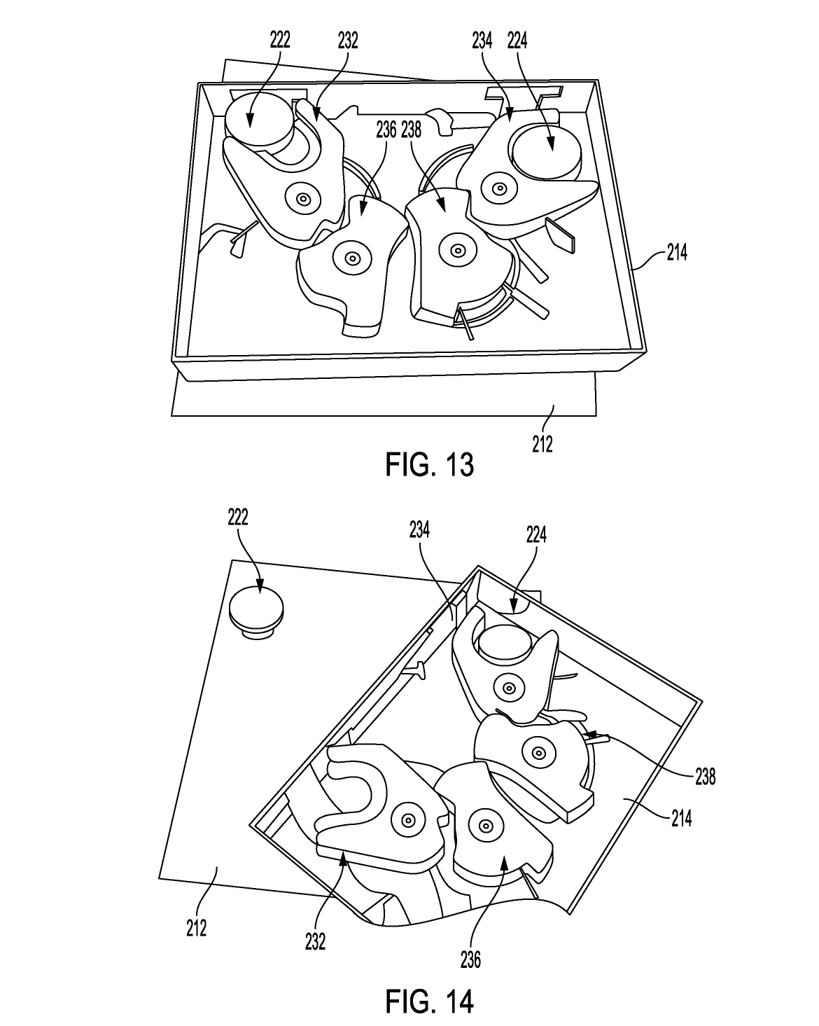

The first and second pivot latches 32, 34 each include respective first and second retaining surfaces 62, 64 and first and second catch surfaces 66, 68, as shown in FIGS. 9-10. Each retaining surface 62, 64 is configured to engage with outside surfaces 70 of the respective striker 22, 24 in the travel orientation in the respective locked positions and release the strikers 22, 24 in the respective unlocked positions. Each catch surface 66, 68 is configured to engage with respective lock pawls 36, 38.

The first and second lock pawls 36, 38 each include respective first and second pivot latch catches 72, 74, first and second pawl catches 76, 78, and first and second actuator connectors 82, 84 coupled to the first and second actuators 40, 42, respectively, as shown in FIGS. 9-10. Each pivot latch catch 72, 75 is configured to engage the respective catch surface 66, 68 to block movement of respective pivot latches 32, 34 from the locked positions to the unlocked positions. The first pawl catch 76 is configured to block movement of the second lock pawl 38, and the second pawl catch 78 is configured to selectively block movement of the first lock pawl 36. The first actuator 40 is configured to selectively disengage the first pivot latch catch 72 from the first catch surface 66 to free the juvenile seat 14 for pivotable movement about the first pivot axis 18, and the second actuator 42 is configured to selectively disengage the second pivot latch catch 74 from the second catch surface 68 to free the juvenile seat 14 for pivotable movement about the second pivot axis 20.

The first pivot latch catch 72 is biased into engagement with the first catch surface 66 and is configured to automatically lock the first pivot latch 32 in the first locked position when the juvenile seat 14 is returned to the travel orientation. The second pivot latch catch 74 is biased into engagement with the second catch surface 68 and is configured to automatically lock the second pivot latch 34 in the second locked position when the juvenile seat 14 is returned to the travel orientation.

The first pawl catch 76 is configured to selectively engage the second pawl catch 78 to block the second lock pawl 38 from being released when the juvenile seat 14 is in the first pivoted orientation, such that when the first actuator 40 selectively disengages the first pivot latch catch 72 from the first catch surface 66, the first pivot latch 32 is configured to position the first pawl catch 76 in a position that blocks release of the second pivot latch catch 74, until the juvenile seat 14 returns to the travel orientation. The second pawl catch 78 is configured to selectively engage the first pawl catch 76 to block the first lock pawl 36 from being released when the juvenile seat 14 is in the second pivoted orientation, such that when the second actuator 42 selectively disengages the second pivot latch catch 74 from the second catch surface 68, the second pivot latch 34 is configured to position the second pawl catch 78 in a position that blocks release of the first pivot latch catch 72, until the juvenile seat 14 returns to the travel orientation. In this manner, both pivot latches 32, 34 cannot be released at the same time.

In the illustrative embodiment, the lock controller 26 further includes a lock support 27 spanning the first pivot lock 28 and the second pivot lock 30 and coupled to each pivot latch 32, 34 and lock pawl 36, 38 as shown in FIGS. 4 and 5. The lock support 27 is made of a rigid material, such as metal, and is formed with apertures that receive pivot rods or axles included in each of the pivot latches 32, 34, and lock pawls 36, 38 to support the pivot latches 32, 34 and lock pawls 36, 38 for pivotable movement relative to the lock support 27. The lock support 27 is configured to maintain spacing between the each of the pivot latches 32, 34 and lock pawls 36, 38. The lock support 27 ties each of these components together so that they cannot move laterally toward or away from one another during operation of the lock controller 26. For example, if the first lock pawl 36 were to move away from the second lock pawl 38, then one or both of the lock pawls 36, 38 may not be able to block the other from unlocking and the juvenile seat 14 may completely detach from the seat base 12. In some embodiments, a lock support 27 is included separately with the first pivot lock 28 and the second pivot lock 30 such that the lock supports 27 do not span the first pivot lock 28 and the second pivot lock 30. Such embodiments of the lock support 27 allow other areas of the child restraint 10 to be made of less rigid materials, such as a plastic material, to save cost and reduce weight. In some embodiments, the housing 44 is made of a rigid material, such as metal, and serves as a lock support.

In a second illustrative embodiment, a child restraint 210 includes a seat base 212, a juvenile seat 214, and a seat-pivot controller 216. The seat base 212 is configured to be attached to a vehicle seat of a vehicle. The juvenile seat 214 is configured to secure and restrain a child for transportation in the vehicle. The seat-pivot controller 216 is configured to control movement of the juvenile seat 214 relative to the seat base 212 from a travel orientation to a first pivoted orientation or a second pivoted orientation.

The seat pivot controller 216 establishes a first pivot axis 218 and a second pivot axis 220, both of which are offset laterally from a front-to-back centerline 200 of the seat base 212. The seat-pivot controller 216 allows the juvenile seat 214 to pivot about the first pivot axis 218 to the first pivoted orientation to position the juvenile seat 214 closer to an open passenger-side door of the vehicle for facilitated placement of a child into the juvenile seat 214. The seat-pivot controller 216 allows the juvenile seat 214 to pivot about the second pivot axis 220 to the second pivoted orientation to position the juvenile seat 214 closer to an open driver-side door of the vehicle for facilitated placement of a child into the juvenile seat 214.

The seat-pivot controller 216 includes a first pivot post 222 coupled to the seat base 212, a second pivot post 224 coupled to the seat base 212, and a pivot lock assembly 226 coupled to the juvenile seat 214 for movement therewith. The first and second pivot posts 222, 224 establish the first and second pivot axes 218, 220, respectively. The pivot-lock assembly 226 is configured to engage selectively with the first pivot post 222 and the second pivot post 224 to block movement of the juvenile seat 214 relative to the seat base 212 in the travel orientation. The pivot-lock assembly 226 is configured to release from the first pivot post 222 to allow pivoting of the juvenile seat 214 relative to the seat base 212 about the second pivot axis 220 to the second pivoted orientation. The pivot-lock assembly 226 is configured to release from the second pivot post 224 to allow pivoting of the juvenile seat 214 relative to the seat base 212 about the first pivot axis 218 to the first pivoted orientation.

The pivot-lock assembly 226 includes a first pivot lock 228 and a second pivot lock 230. The first pivot lock 228 is configured to engage selectively with the first pivot post 222 in the travel orientation to block movement of the juvenile seat 214 relative to the seat base 212. The second pivot lock 230 is configured to engage selectively with the second pivot post 224 in the travel orientation to block movement of the juvenile seat 214 relative to the seat base 212.

The first and second pivot locks each include a pivot latch 232, 234, a lock pawl 236, 238, and an actuator 240, 242. Each pivot latch 232, 234 is configured to engage with a respective pivot post 222, 224 in the travel orientation in a locked position and releases the respective pivot post in an unlocked position. Each lock pawl 236, 238 is configured to engage the respective pivot latch 232, 234 to block movement of the pivot latch 232, 234 from the locked position to the unlocked position. The actuators 240, 242 can include one or more of a handle, cable, button, lever, etc. and are operated by a user to disengage one of the lock pawls 236, 238 from the respective pivot latch 232, 234 to free the juvenile seat 214 for pivotable movement about the first or second pivot axes 218, 220.

The pivot latches 232, 234 are biased toward the unlocked position by a spring for example, to automatically release the pivot post 222, 224 when the lock pawl 236, 238 is released. The lock pawls are biased into engagement with each respective pivot latch 232, 234 to automatically lock the pivot latches 232, 234 in the locked position around the pivot posts 222, 224 when the juvenile seat 214 is returned to the travel orientation.

Both lock pawls 236, 238 are structured and positioned relative to one another to block the other from being released when the juvenile seat 214 is in one of the pivoted orientations. When pivot latch 232 is released, the pivot latch 232 positions lock pawl 36 in a position that blocks release of the lock pawl 238. When pivot latch 234 is released, the pivot latch 234 positions lock pawl 238 in a position that blocks release of the lock pawl 236. Thus, both pivot latches 232, 234 cannot be released at the same time.

1. A child restraint, comprising
a seat base configured to be attached to a vehicle seat of a vehicle;
a juvenile seat configured to secure and restrain a child for transportation in the vehicle; and
a seat-pivot controller configured to control movement of the juvenile seat relative to the seat base from a travel orientation to a first pivoted orientation or a second pivoted orientation, and having a first striker coupled to the seat base, a second striker coupled to the seat base and offset in a first lateral direction from the first striker, and a lock controller coupled to the juvenile seat for movement therewith and configured to engage selectively with the first striker and the second striker in the travel orientation to block movement of the juvenile seat relative to the seat base from the travel orientation to the first pivoted orientation and the second pivoted orientation, the lock controller is configured to release from the first striker to allow pivoting of the juvenile seat relative to the seat base about the second striker to the second pivoted orientation, and the lock controller is configured to release from the second striker to allow pivoting of the juvenile seat relative to the seat base about the first striker to the first pivoted orientation.

2. The child restraint of claim 1, wherein the seat-pivot controller is configured to allow the juvenile seat to pivot about a first pivot axis, defined by the first striker and offset in a first lateral direction from a front-to-back centerline of the seat base, to the first pivoted orientation to position the juvenile seat towards an open passenger-side door of the vehicle, and wherein the seat-pivot controller is configured to allow the juvenile seat to pivot about a second pivot axis, defined by the second striker and offset in a second lateral direction, opposite the first lateral direction, from the front-to-back centerline of the seat base to the second pivoted orientation to position the juvenile seat towards an open driver-side door of the vehicle.

3. The child restraint of claim 2, wherein the lock controller further comprises
a housing coupled to the juvenile seat and configured to rotate relative to the seat base with the juvenile seat, and formed to include a first slot configured to selectively engage with the first striker, a second slot configured to selectively engage with the second striker;
a first pivot lock coupled to the housing for movement therewith and configured to engage selectively with the first striker in the travel orientation to block movement of the juvenile seat relative to the seat base, and having a first pivot latch, a first lock pawl configured to retain the first pivot latch in a first locked position, and a first actuator configured to release the first lock pawl from the first pivot latch such that the first pivot latch is free to move from the first locked position to a first unlocked position; and
a second pivot lock coupled to the housing for movement therewith and configured to move independently of the first pivot lock and engage selectively with the second striker in the travel orientation to block movement of the juvenile seat relative to the seat base, and having a second pivot latch, a second lock pawl configured to retain the second pivot latch in a second locked position, and a second actuator configured to release the second lock pawl from the second pivot latch such that the second pivot latch is free to move from the second locked position to a second unlocked position.

4. The child restraint of claim 3, wherein the juvenile seat is configured to selectively change between a locked configuration, in which both the first pivot latch and the second pivot latch are in the first locked position and the second locked position, respectively, and an unlocked configuration, in which either the first pivot latch or the second pivot latch is in either of the first unlocked position or the second unlocked position, respectively.

5. The child restraint of claim 3, wherein the first pivot latch comprises a first retaining surface configured to engage with an outside surface of the first striker in the travel orientation in the first locked position and release the first striker in the first unlocked position and a first catch surface configured to engage with the first lock pawl and
the second pivot latch further comprises a second retaining surface configured to engage with an outside surface of the second striker in the travel orientation in a second locked position and release the second striker in a second unlocked position and a second catch surface configured to engage with the second lock pawl.

6. The child restraint of claim 5, wherein the first lock pawl comprises a first pivot latch catch configured to engage the first catch surface to block movement of the first pivot latch from the first locked position to the first unlocked position, a first pawl catch configured to block movement of the second lock pawl, and a first actuator connector coupled to the first actuator and
the second lock pawl further comprises a second pivot latch catch configured to engage the second catch surface to block movement of the second pivot latch from the second locked position to the second unlocked position, a second pawl catch configured to selectively block movement of the first lock pawl, and a second actuator connector coupled to the second actuator.

7. The child restraint of claim 6, wherein the first pivot latch catch is biased into engagement with the first catch surface and is configured to automatically lock the first pivot latch in the first locked position when the juvenile seat is returned to the travel orientation, and the second pivot latch catch is biased into engagement with the second catch surface and is configured to automatically lock the second pivot latch in the second locked position when the juvenile seat is returned to the travel orientation.

8. The child restraint of claim 6, wherein the first pawl catch is configured to selectively engage the second pawl catch to block the second lock pawl from being released when the juvenile seat is in the first pivoted orientation, such that when the first actuator selectively disengages the first pivot latch catch from the first catch surface, the first pivot latch is configured to position the first pawl catch in a position that blocks release of the second pivot latch catch, until the juvenile seat returns to the travel orientation and
and the second pawl catch is configured to selectively engage the first pawl catch to block the first lock pawl from being released when the juvenile seat is in the second pivoted orientation, such that when the second actuator selectively disengages the second pivot latch catch from the second catch surface, the second pivot latch is configured to position the second pawl catch in a position that blocks release of the first pivot latch catch, until the juvenile seat returns to the travel orientation.

9. The child restraint of claim 3, wherein the first actuator is configured to disengage the first lock pawl from the first pivot latch to free the juvenile seat for pivotable movement about the first pivot axis, and the second actuator is configured to disengage the second lock pawl from the second pivot latch to free the juvenile seat for pivotable movement about the second pivot axis.

10. The child restraint of claim 9, wherein the first actuator is configured to selectively disengage the first pivot latch catch from the first catch surface to free the juvenile seat for pivotable movement about the first pivot axis, and the second actuator is configured to selectively disengage the second pivot latch catch from the second catch surface to free the juvenile seat for pivotable movement about the second pivot axis.

11. The child restraint of claim 3, wherein the first pivot latch is biased toward the first unlocked position by a spring and is configured to automatically release the first striker when the first lock pawl is released, and the second pivot latch is biased toward the second unlocked position by a spring and is configured to automatically release the second striker when the second lock pawl is released.

12. The child restraint of claim 3, wherein the first lock pawl is biased into engagement with the first pivot latch and is configured to automatically lock the first pivot latch in the first locked position when the juvenile seat is returned to the travel orientation, and the second lock pawl is biased into engagement with the second pivot latch and is configured to automatically lock the second pivot latch in the second locked position when the juvenile seat is returned to the travel orientation.

13. The child restraint of claim 3, wherein the first lock pawl and the second lock pawl are configured to block each other from being released when the juvenile seat is in the first pivoted orientation or the second pivoted orientation, such that when the first pivot latch is released, the first pivot latch is configured to position the first lock pawl in a position that blocks release of the second lock pawl, and when the second pivot latch is released, the second pivot latch is configured to position the second lock pawl in a position that blocks release of the first lock pawl.

14. The child restraint of claim 3, wherein the first pivot latch includes a first post retainer and a first latch return spaced apart from the first post retainer to provide a first post-receiving space between the first post retainer and the first latch return, and wherein the first post retainer extends across the first slot to at least partially enclose the first striker in the first slot when the juvenile seat is in the travel orientation and the second pivoted orientation, and the first post retainer is misaligned with the first slot when the first pivot latch is in the first locked position to free the first striker for movement to the first pivoted orientation, and wherein the first latch return extends across the first slot when the first pivot latch is in the first unlocked position to engage the first striker during movement of the juvenile seat from the first pivoted orientation to the travel orientation to return the first pivot latch to the first locked position when the juvenile seat reaches the travel orientation and
wherein the second pivot latch includes a second post retainer and a second latch return spaced apart from the second post retainer to provide a second post-receiving space between the second post retainer and the second latch return, and wherein the second post retainer extends across the second slot to at least partially enclose the second striker in the second slot when the juvenile seat is in the travel orientation and the first pivoted orientation, and the second post retainer is misaligned with the second slot when the second pivot latch is in the second locked position to free the second striker for movement to the second pivoted orientation, and wherein the second latch return extends across the second slot when the second pivot latch is in the second unlocked position to engage the second striker during movement of the juvenile seat from the second pivoted orientation to the travel orientation to return the second pivot latch to the second locked position when the juvenile seat reaches the travel orientation

15. A seat-pivot controller for a child restraint, configured to control movement of a juvenile seat relative to a seat base from a travel orientation to a first pivoted orientation and a second pivoted orientation, the seat-pivot controller comprising
a first striker;
a second striker offset in a first lateral direction from the first striker; and
a lock controller coupled to the juvenile seat for movement therewith and configured to engage selectively with the first striker and the second striker in the travel orientation to block movement of the lock controller from the travel orientation to the first pivoted orientation and the second pivoted orientation, the lock controller is configured to release from the first striker to allow pivoting of lock controller about the second striker to the second pivoted orientation, and the lock controller is configured to release from the second striker to allow pivoting of lock controller about the first striker to the first pivoted orientation.

16. The seat-pivot controller of claim 15, wherein the lock controller comprises
a housing formed to include a first slot configured to receive the first striker and a second slot configured to receive the second striker;
a first pivot lock coupled to the housing for movement therewith and configured to engage selectively with the first striker in the travel orientation to block movement of the lock controller, the first pivot lock having a first pivot latch, a first lock pawl configured to retain the first pivot latch in a first locked position, and a first actuator configured to release the first lock pawl from the first pivot latch so that the first pivot latch is free to move from the first locked position to a first unlocked position; and
a second pivot lock coupled to the housing for movement therewith and configured to move independently of the first pivot lock and engage selectively with the second striker in the travel orientation to block movement of the lock controller, the second pivot lock having a second pivot latch, a second lock pawl configured to retain the second pivot latch in a second locked position, and a second actuator configured to release the second lock pawl from the second pivot latch so that the second pivot latch is free to move from the second locked position to a second unlocked position.

17. The seat-pivot controller of claim 16, wherein the lock controller is configured to selectively change between a locked configuration, in which both the first pivot latch and the second pivot latch are in the first locked position and second locked position, respectively, and an unlocked configuration, in which the first pivot latch is in the first unlocked position and the second pivot latch is in the second locked position.

18. The seat-pivot controller of claim 17, wherein the first pivot latch further comprises a first retaining surface configured to engage with an outside surface of the first striker in the travel orientation in the first locked position and release the first striker in the first unlocked position and a first catch surface configured to engage with the first lock pawl, and
the second pivot latch further comprises a second retaining surface configured to engage with an outside surface of the second striker in the travel orientation in a second locked position and release the second striker in a second unlocked position and a second catch surface configured to engage with the second lock pawl.

19. The seat-pivot controller of claim 18, wherein the first lock pawl further comprises a first pivot latch catch configured to engage the first catch surface to block movement of the first pivot latch from the first locked position to the first unlocked position, a first pawl catch configured to selectively block movement of the second lock pawl, and a first actuator connector coupled to the first actuator, and
the second lock pawl further comprises a second pivot latch catch configured to engage the second catch surface to block movement of the second pivot latch from the second locked position to the second unlocked position, a second pawl catch configured to selectively block movement of the first lock pawl, and a second actuator connector coupled to the second actuator.

20. The seat-pivot controller of claim 17, wherein the first pivot latch includes a first post retainer and a first latch return spaced apart from the first post retainer to provide a first post-receiving space between the first post retainer and the first latch return, and wherein the first post retainer extends across the first slot to at least partially enclose the first striker in the first slot when the lock controller is in the travel orientation and the second pivoted orientation, and the first post retainer is misaligned with the first slot when the first pivot latch is in the first locked position to free the lock controller for movement to the first pivoted orientation, and wherein the first latch return extends across the first slot when the first pivot latch is in the first unlocked position to engage the first striker during movement of the lock controller from the first pivoted orientation to the travel orientation to return the first pivot latch to the first locked position when the lock controller reaches the travel orientation, and
wherein the second pivot latch includes a second post retainer and a second latch return spaced apart from the second post retainer to provide a second post-receiving space between the second post retainer and the second latch return, and wherein the second post retainer extends across the second slot to at least partially enclose the second striker in the second slot when the lock controller is in the travel orientation and the first pivoted orientation, and the second post retainer is misaligned with the second slot when the second pivot latch is in the second locked position to free the lock controller for movement to the second pivoted orientation, and wherein the second latch return extends across the second slot when the second pivot latch is in the second unlocked position to engage the second striker during movement of the lock controller from the second pivoted orientation to the travel orientation to return the second pivot latch to the second locked position when the lock controller reaches the travel orientation.
